(19) United States
(12) Patent Application Publication
(10) Pub. No.: US 2021/0184478 A1
(43) Pub. Date: Jun. 17, 2021

(54) CHARGING APPARATUS AND CONTROL METHOD THEREOF

(71) Applicants: HYUNDAI MOTOR COMPANY, SEOUL (KR); KIA MOTORS CORPORATION, SEOUL (KR); YURA CORPORATION CO.,LTD., SEONGNAM-SI (KR)

(72) Inventors: Yun Jae Jung, Suwon-si (KR); Chang Woo Shin, Hwaseong-si (KR); Do Kyeong Lee, Gwangju-si (KR); Woo Gwon Sim, Seongnam-si (KR); Dae Hwan Kwon, Seongnam-si (KR); Min Kyu Lim, Seongnam-si (KR)

(21) Appl. No.: 17/119,151

(22) Filed: Dec. 11, 2020

(30) Foreign Application Priority Data
Dec. 16, 2019 (KR) 10-2019-0168180

(51) Int. Cl. H02J 7/00

(52) U.S. Cl. CPC H02J 7/0045; H02J 7/0047; B60L 53/16; H02J 7/00712; H02J 7/00032

(57) ABSTRACT

Disclosed is a charging apparatus including a first power source connector connectable to a charging station power source, a second power source connector connectable to a commercial power source, a cable connected to the first power source connector and the second power source connector, and a. controller including a power source terminal connected to the first power source connector or the second power source connector via the cable and controlling the intensity of a charging supply current when the first power source connector or the second power source connector is connected to the power source terminal.

### CROSS REFERENCE TO RELATED APPLICATIONS

This application is based on and claims priority under 35 U.S.C. § 119 to Korean Patent Application No. 10-2019-0168180, filed on Dec. 16, 2019, in the Korean Intellectual Property Office, the disclosure of which is incorporated by reference herein in its entirety.

### BACKGROUND

### 1. Field

The disclosure relates to a charging apparatus and a control method thereof, and more particularly, to a charging device and a control method capable of adjusting the intensity of a charging current according to an input power source using a single cable.

### 2. Description of the Related Art

In a conventional method of charging an electric vehicle or a hybrid vehicle, there are a method of charging using a charging station and a method of charging using a portable power cord.

In order to charge an electric vehicle or a hybrid vehicle using the above two methods, a user needs to have two types of charging cables.

In a case where charging an electric vehicle or a hybrid vehicle using a portable power cord, a lot of charging time is required due to a low charging current, and a user needs to move to a charging station for fast charging.

In addition, as two types of cables are alternately mounted, the durability of the cables is reduced.

### SUMMARY

It is an aspect of the disclosure to provide a charging apparatus including a controller capable of determining a connected power source using a single cable and adjusting the intensity of a charging supply current, and a control method thereof.

It is another aspect of the disclosure to provide a charging apparatus including a waterproof and durable power source connector, and a control method thereof.

Additional aspects of the disclosure will be set forth in part in the description which follows and, in part, will be obvious from the description, or may be learned by practice of the disclosure.

In accordance with an aspect of the disclosure, a charging apparatus includes a first power source connector connectable to a charging station power source, a second power source connector connectable to a commercial power source, a cable connected to the first power source connector and the second power source connector, and a controller including a power source terminal connected to the first power source connector or the second power source connector via the cable and controlling the intensity of a charging supply current when the first power source connector or the second power source connector is connected to the power source terminal.

The controller may be configured to determine an intrinsic resistance value of the connected power source and adjust the intensity of the charging supply current based on the determination result.

The controller may be configured to monitor a state of being charged by the charging supply current.

The charging apparatus may further include a charge breaker, wherein the controller may be configured to determine the monitoring result and control the charge breaker to stop charging when it is determined that charging is complete.

The controller may be configured to accept a charging supply current of 32A and determine the charging supply current.

The controller may be configured to accept a charging supply voltage of 110V to 230V and determine the charge supply voltage.

The first power source connector and the second power source connector each may include a cover having a screw thread.

The cover may include a waterproof material.

The first power source connector and the second power source connector may be provided to be cross-detachable.

The charging apparatus may further include a communication device communicating with the charge breaker, wherein the controller may be configured to control the charge breaker to supply a charging current based on a communication result of the communication device.

In accordance with an aspect of the disclosure, a control method of a charging apparatus includes connecting at least one of a first power source connector and a second power source connector to at least one of a charging station power source and a commercial power source, determining a power source connector connected to the power source among the first power source connector and the second power source connector by a controller, and controlling to adjust the intensity of a charging supply current based on the determination result.

The controlling may include determining an intrinsic resistance value of the connected power source and adjusting the intensity of the charging supply current based on the determination result.

The controlling may include monitoring a state of being charged by the charging supply current.

The controlling may include determining the monitoring result and controlling a charge breaker to stop charging when it is determined that charging is complete.

The controlling may include accepting a charging supply current of 32A and determining the charging supply current.

The controlling may include accepting a charging supply voltage of 110V to 230V and determining the charge supply voltage.

The controlling may include controlling a duty ratio of a charge breaker signal when the second power source connector is connected to the power source.

The controlling may include changing the duty ratio based on a user input, wherein the control method may further include changing the intensity of the charging supply current when the duty ratio is changed.

The controlling may include stopping control of the duty ratio when the first power source connector is connected to the power source.

The control method may further include communicating with the charge breaker, wherein the controlling may include controlling the charge breaker to supply a charging current based on a communication result.

### BRIEF DESCRIPTION OF THE FIGURES

These and/or other aspects of the disclosure will become apparent and more readily appreciated from the following description of the embodiments, taken in conjunction with the accompanying drawings of which:

FIG. 1 illustrates a vehicle, a power source, and a charging apparatus according to an embodiment of the disclosure;

FIG. 2 is a control block diagram of the charging apparatus according to an embodiment of the disclosure;

FIG. 3 is a detailed charging system configuration diagram of the charging apparatus according to an embodiment of the disclosure;

FIG. 4 is a flowchart illustrating processes in which a controller of the charging apparatus according to an embodiment of the disclosure adjusts the intensity of a charging supply current;

FIG. 5 is a flowchart illustrating processes in which the controller of the charging apparatus according to an embodiment of the disclosure monitors the charging supply current;

FIGS. 6A, 6B, and 6C illustrate processes of connecting a power source connector to the controller of the charging apparatus according to an embodiment of the disclosure; and

FIG. 7 illustrates a waterproof structure of the power source connector of the charging apparatus according to an embodiment of the disclosure.

### DETAILED DESCRIPTION

Like reference numerals refer to like elements throughout the specification. This specification does not describe all the elements of the embodiments, and duplicative contents between general contents or embodiments in the technical field of the present disclosure will be omitted. The terms ‘part,’ module, ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being “connected” to another part, it includes not only a direct connection but also an indirect connection, and the indirect connection includes connecting through a wireless network.

Also, when it is described that a part “includes” an element, it means that the element may further include other elements, not excluding the other elements unless specifically stated otherwise.

Throughout the specification, when a member is described as being “on” another member, this includes not only a case where one member is adjacent to the other member, but also a case where another member is placed between the two members.

The terms ‘first,’ ‘second,’ etc. are used to distinguish one element from another element, and the elements are not limited by the above-mentioned terms.

The singular forms “a,” “an,” and “the” include plural referents unless the context clearly dictates otherwise.

In each step, an identification numeral is used for convenience of explanation, the identification numeral does not describe the order of the steps, and each step may be performed differently from the order specified unless the context clearly states a particular order.

Hereinafter the disclosure will be described in detail with reference to the accompanying drawings.

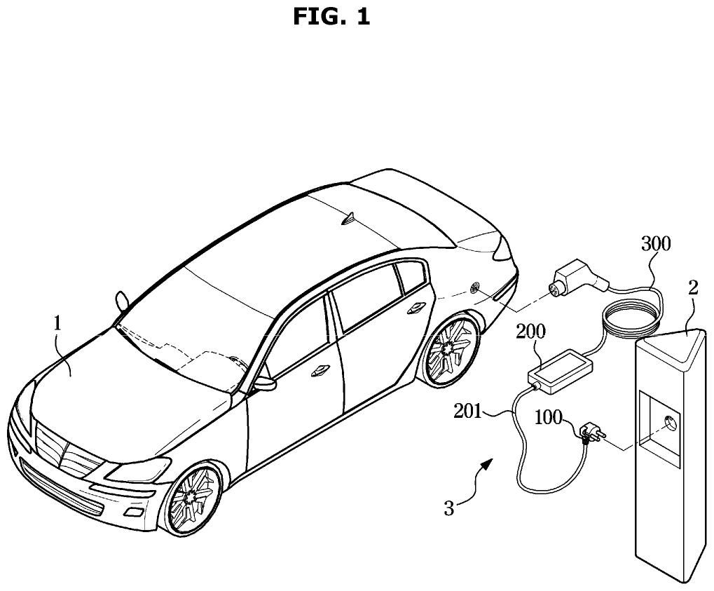

FIG. 1 illustrates a vehicle 1, a power source 2, and a charging apparatus 3 according to an embodiment of the disclosure.

Referring to FIG. 1, the vehicle 1 may include an electric vehicle, a hybrid vehicle, or a plug-in hybrid vehicle.

The power source 2 may be a charging station power source or a commercial power source. The commercial power source may have a voltage value of 110V to 230V used in a general home.

The charging apparatus 3 includes a power source connector 100, a controller 200, a cable 201, and a charging connector 300. The charging apparatus 3 may further include a charge breaker 400 or a communication device 500.

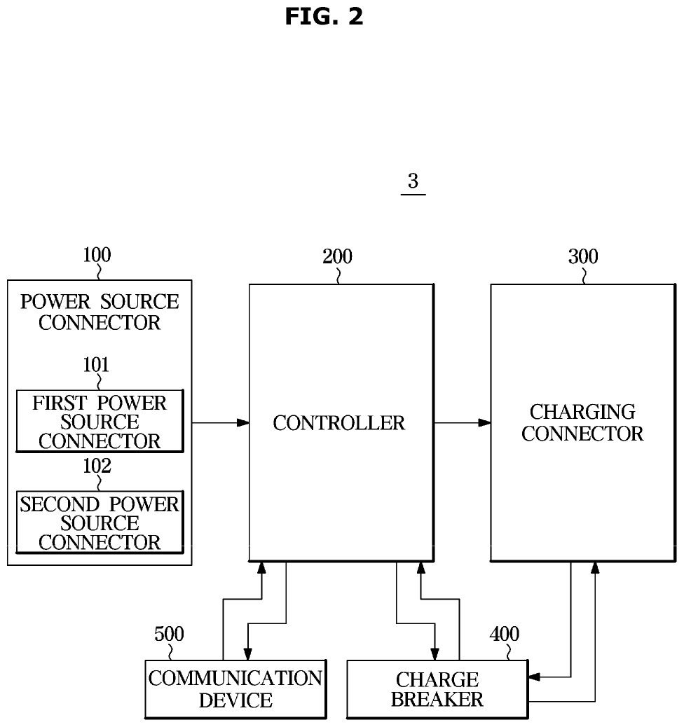

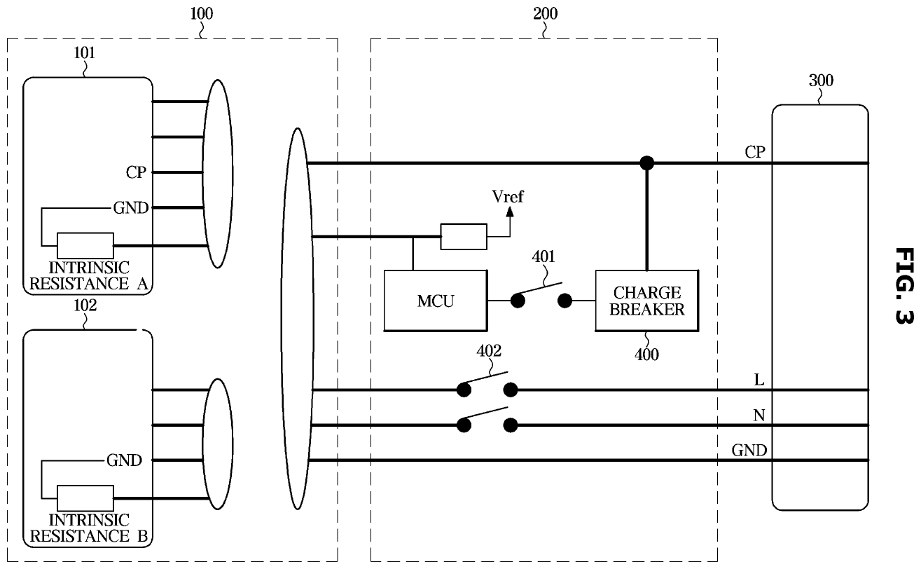

FIG. 2 is a control block diagram of the charging apparatus 3 according to an embodiment of the disclosure, and FIG. 3 is a detailed charging system configuration diagram of the charging apparatus 3 according to an embodiment of the disclosure.

Referring to FIG. 2, the charging apparatus 3 may include a first power source connector 101 that may be connected to a charging station power source, a second power source connector 102 that may be connected to a commercial power source, the controller 200, the charging connector 300, the charge breaker 400 or the communication device 500.

The first power source connector 101 according to an embodiment of the disclosure may be connected to a power source provided in a charging station, and the second power source connector 102 may be connected to a commercial power source. The first power source connector 101 may withstand a higher voltage than the second power source connector 102. In addition, the first power source connector 101 and the second power source connector 102 are provided to be cross-detachable depending on the type of the power source 2.

Voltages that may be accepted by the first power source connector 101 and the second power source connector 102 may be 110V to 230V, but are not limited thereto.

A current that may be accepted by the first power source connector 101 may be up to 32A, and a current that may be accepted by the second power source connector 102 may be up to 12A, but are not limited thereto.

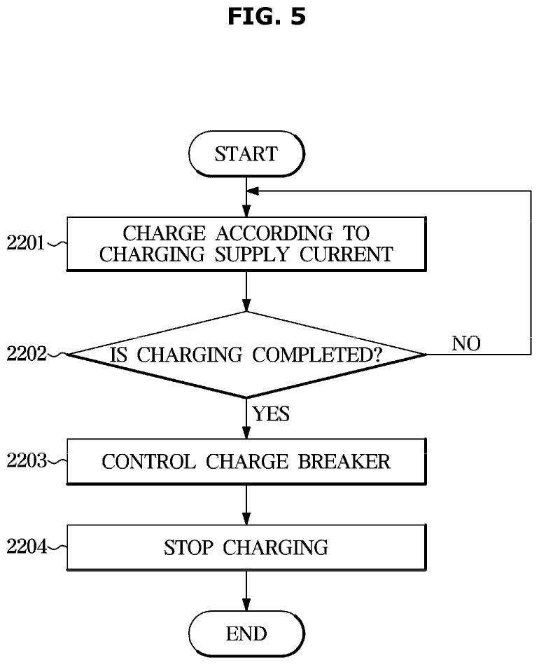

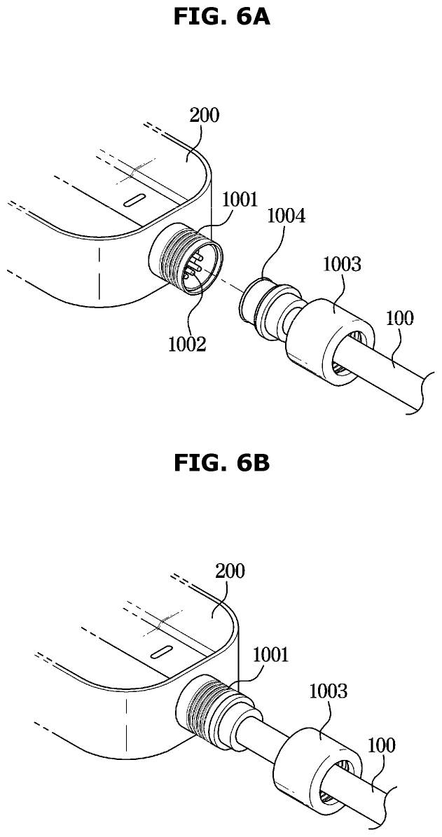

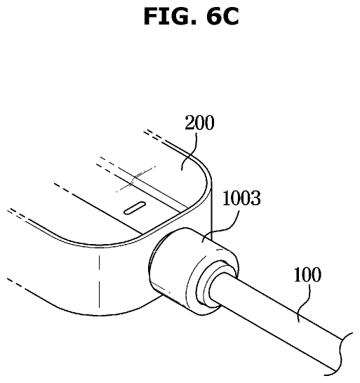

The structures of the first power source connector 101 and the second powersource connector 102 will be described later with reference to FIGS. 5 and 6.

Referring to FIG. 3, the power source connector 100 is connected to the controller 200, and the controller 200 is connected to the charging connector 300.

The controller 200 may include a micro controller unit (MCU) and the charge breaker 400.

The charge breaker 400 may control a CP circuit 401 or a relay 402 provided in the controller 200. Specifically, when it is determined that the first power source connector 101 is connected to the power source 2, the controller 200 controls the charge breaker 400 not to generate a CP signal, and as a result, the CP circuit 401 is opened, and the relay 402 is connected.

When the second power source connector 102 is connected, the controller 200 may control the charge breaker 400 so that the CP circuit 401 is connected.

The cable 201 according to an embodiment of the disclosure connects the controller 200 to the first power source connector 101 or the second power source connector 102. A voltage that may be accepted by the cable 201 may be 110V to 230V, but is not limited thereto.

The controller 200 according to an embodiment of the disclosure includes a power source terminal connected to a first power source connector 101 or the second power source connector 102 via a cable 201 and adjusts the intensity of a charging supply current when the first power source connector 101 or the second power source connector 102 is connected to the power source terminal.

The controller 200 may determine an intrinsic resistance of the connected power source 2, and determine the connected power source 2 based on the determination result.

Specifically, according to an embodiment of the disclosure, the first power source connector 101 may have an intrinsic resistance value of 3 kΩ, and the second power source connector 102 may have an intrinsic resistance value of 1 kΩ.

When the first power source connector 101 according to an embodiment of the disclosure is connected to the power source 2, the controller 200 may distribute the voltage based on the intrinsic resistance value of the first power source connector 101.

Specifically, referring to FIG. 3, the controller 200 may set a reference voltage Vref and include a reference resistance (Ref resistance). The reference resistors present inside the power source connector 100 and the controller 200 may be connected in series.

According to an embodiment of the disclosure, in a case where the reference voltage is 5V and the reference resistance is 1 kΩ, when the first power source connector 101 having the intrinsic resistance value of 3 kΩ is connected to the power source 2, a voltage of 3.75V may be distributed to the first power source connector 101.

Also, when the second power source connector 102 having the intrinsic resistance value of 1 kΩ is connected to the power source 2, a voltage of 2.5 V may be distributed to the second power source connector 102.

However, the above-described voltage values are only an example, and may vary depending on the voltage applied to the power source 2.

When it is determined that the first power source connector 101 is connected to the power source 2, the controller 200 may block the control signal and allow charging of the vehicle 1.

When the second power source connector 102 according to an embodiment of the disclosure is connected to the power source 2, the controller 200 may distribute the voltage based on the intrinsic resistance value of the second power source connector 102.

The controller 200 may convert a voltage value into a digital signal. For example, the controller 200 may utilize an analog-to-digital converter (ADC), and when the input voltage is alternating current, may convert it into direct current to set a reference voltage.

When it is determined that the second power source connector 102 is connected to the power source 2, the controller 200 may adjust a duty ratio of a CP signal or a relay signal.

When charging starts, the controller 200 may adjust the current supplied to the vehicle 1 by adjusting the duty ratio of the CP signal or the relay signal.

The controller 200 may adjust the intensity of the charging supply current based on the connected power source 2 and monitor a state of being charged by the charging supply current.

A voltage that may be accepted by the controller 200 may be 110V to 230V, but is not limited thereto. A current that may be accepted by the controller 200 may be up to 32A, but is not limited thereto.

The controller 200 according to an embodiment of the disclosure may include the charge breaker 400 and communicate with the charge breaker 400. The controller 200 may control the supply of the charging supply current through the control of the charge breaker 400.

The controller 200 may be implemented as a memory (not shown) for storing an algorithm for controlling the operation of components in the charging apparatus 3 or data for a program reproducing the algorithm and a processor (not shown) for performing the above-described operations using data stored in the memory. The memory may be implemented as a separate chip from the processor, and may be implemented as a single chip with the processor.

The charging connector 300 according to an embodiment of the disclosure is connectable to the vehicle 1 and connects the controller 200 to the vehicle 1. The voltage that the charging connector 300 may accept may be 110V to 230V, but is not limited thereto. A current that the charging connector 300 may accept may be up to 32A, but is not limited thereto.

The charge breaker 400 according to an embodiment of the disclosure communicates with the controller 200 and adjusts the supply of charging current,

The charge breaker 400 may control the CP circuit 401 or the relay 402, but is not limited thereto. A signal of the charge breaker 400 may be the CP signal or the relay signal, but is not limited thereto.

Specifically, when the second power source connector is connected to the power source 2, the charge breaker 400 may adjust the supply current through duty ratio control. The controller 200 may monitor the state of charge by PWM control of the charge breaker 400.

The communication device 500 according to an embodiment of the disclosure allows communication of information on the charging supply current between the controller 200 and the charge breaker 400. The information on the charging supply current may be whether charging is completed, the intensity of the charging supply current or the intensity of a charging supply voltage, whether a circuit is abnormal, or whether normal charging is performed, but is not limited thereto.

The communication device 500 may include one or more components that enable communication with an external device, and may include, for example, at least one of a short range communication module, a wired communication module, and a wireless communication module.

At least one component may be added or removed corresponding to the performance of the components of the charging apparatus 3 illustrated in FIGS. 1 to 3. It will be readily understood by those skilled in the art that the mutual location of components may be changed in consideration of the performance or structure of the system.

The respective components illustrated in FIG. 2 refers to software and/or hardware components such as a field programmable gate array (FPGA) and an application specific integrated circuit (ASIC).

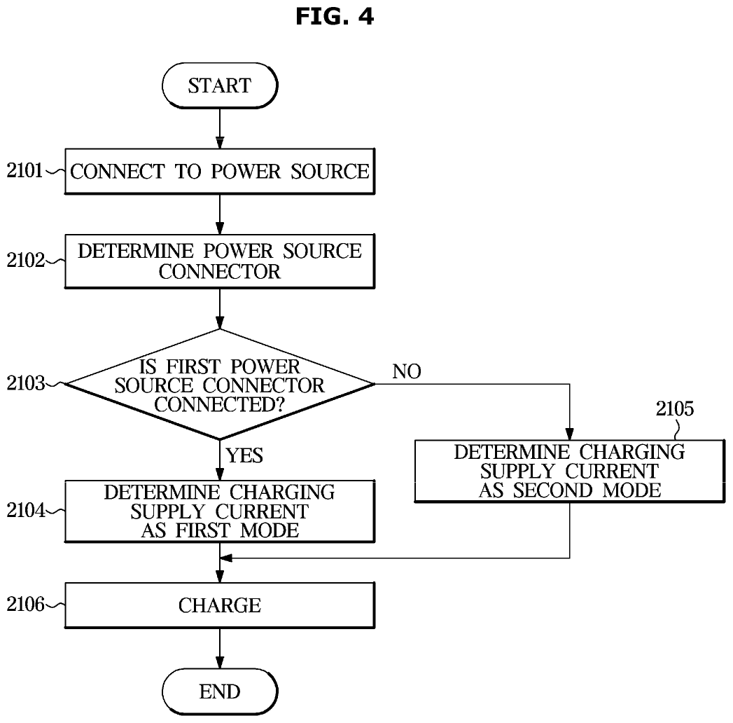

FIG. 4 is a flowchart illustrating processes in which the controller 200 according to an embodiment of the disclosure adjusts the intensity of a charging supply current.

Referring to FIG. 4, the controller 200 determines whether the power source 2 is connected to the first power source connector 101 or the second power source connector 102 and determines the type of the connected power source connector at 2101 and 2102.

Specifically, the controller 200 may determine whether the first power source connector 101 is connected to the power source 2 or the second power source connector 102 is connected to the power source 2, based on the intrinsic resistance value of the connected power source 2.

When it is determined that the first power source connector 101 is connected to the power source 2, the controller 200 determines the charging supply current according to a first mode at 2103 and 2104.

Specifically, when it is determined that the first power source connector 101 is connected to the power source 2, the controller 200 recognizes as the first mode and may transmit the information of the power source 2 to the vehicle 1. When the vehicle 1 receives the information of the power source 2 corresponding to the first mode, the controller 200 may supply a current of 32A to the vehicle 1.

Referring to FIG. 3, the controller 200 may block the CP signal and connect the relay 402 to adjust the magnitude of current. According to an embodiment of the disclosure, when the controller 200 blocks the CP signal and connects the relay 402, a high current may be supplied to the vehicle 1.

However, when it is determined that the power source 2 is not connected to the first power source connector 101, the controller 200 determines the charging supply current according to a second mode at 2105.

Specifically, when it is determined that the second power source connector 102 is connected to the power source 2, the controller 200 recognizes as the second mode, and may supply a current of 12A, which is a current corresponding to the second mode, to the vehicle 1. The controller 200 may control a PWM duty ratio of the CP circuit 401 or the relay 402.

When a user inputs an appropriate current value, the controller 200 may transmit a CP signal or a relay signal having a duty ratio corresponding to the appropriate current to the vehicle 1. The appropriate current may be determined by the user's input. For example, the appropriate current may be determined according to an appropriate current change instruction input through a current conversion input unit provided outside the charging apparatus 3.

For example, the controller 200, based on a commercial power source value, may set the current intensity to 12A when a value of the PWM duty ratio is 20%, the current intensity to 10A when a value of the PWM duty ratio is 16.66%, the current intensity to 8A when a value of the PWM duty ratio is 13.33%, the current intensity to 7A when a value of the PWM duty ratio is 11.66%, or the current intensity to 6A when a value of the PWM duty ratio is 10%. However, the current intensity is not limited thereto, and may vary depending on the voltage of the power source 2.

When the user inputs a desired current intensity, the controller 200 may control the duty ratio of the CP circuit 401 or the relay 402 to generate a current of the intensity input by the user.

When the charging supply current is determined, the controller 200 performs charging at 2106.

FIG. 5 is a flowchart illustrating processes in which the controller 200 of the charging apparatus 3 according to an embodiment of the disclosure monitors the charging supply current.

Referring to FIG. 5, when the intensity of the charging supply current is determined as illustrated in FIG. 4, the controller 200 performs charging according to the determined charging supply current at 2201.

The controller 200 may monitor whether charging is completed, the intensity of the charging supply current or the intensity of the charging supply voltage, whether the circuit is abnormal, or whether normal charging is performed, but is not limited thereto.

When it is determined that charging of the vehicle 1 is completed, the controller 200 controls the charge breaker 400 at 2202 and 2203.

Specifically, when it is determined that charging of the vehicle 1 is completed, the controller 200 controls the charge breaker 400 to open the CP circuit 401 or the relay 402 and controls the current not to flow. However, when it is determined that charging of the vehicle 1 is not completed, the controller 200 continuously performs charging according to the charging supply current.

Also, when it is determined that charging of the vehicle 1 is completed, the controller 200 stops charging and ends the charging process at 2204.

FIGS. 6A to 6C illustrate processes of connecting the power source connector 100 to the controller 200 of the charging apparatus 3 according to an embodiment of the disclosure.

Referring to FIG. 6A, the controller 200 may be connected to the power source connector 100 through a screw structure.

Specifically, the controller 200 includes a screw thread 1001 and a male terminal 1002, and the power source connector 100 includes a cover 1003 coupled with the screw thread 1001 provided on the controller 200 and a female terminal 1004. The power source connector 100 includes the first power source connector 101 or the second power source connector 102.

Referring to FIG. 6B, the male terminal 1002 provided on the controller 200 may be coupled with the female terminal 1004 provided on the power source connector 100.

Referring to FIG. 6C, the screw thread 1001 provided on the controller 200 may be coupled with the cover 1003 provided on the power source connector 100. Through this process, the controller 200 and the power source connector 100 have a double coupling structure, and as a result, the durability is improved. The cover 1003 may include a waterproof material.

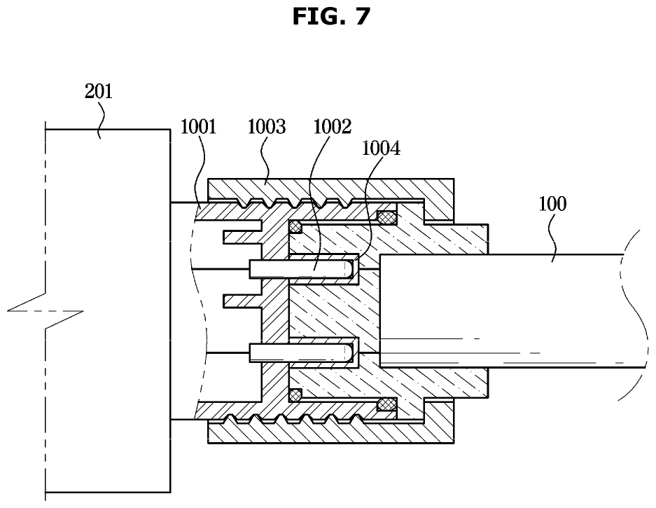

FIG. 7 illustrates a waterproof structure of the power source connector 100 of the charging apparatus 3 according to an embodiment of the disclosure.

Referring to FIG. 7, the controller 200 and the power source connector 100 may be coupled through a double coupling structure.

As described above, the male terminal 1002 provided on the controller 200 may be coupled to the female terminal 1004 provided on the power source connector 100, and in addition to the above coupling structure, the screw thread 1001 provided on the controller 200 may be coupled to the cover 1003 provided on the power source connector 100.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes various kinds of recording media in which instructions which may be decrypted by a computer are stored. For example, there may be a ROM (Read Only Memory), a RAM (Random Access Memory), a magnetic tape, a magnetic disk, a flash memory, an optical data storage device, and the like.

As is apparent from the above, a charging apparatus according to an embodiment of the disclosure can improve the convenience of charging by using a single cable.

Further, the charging apparatus according to an embodiment of the disclosure can improve durability by including a cable connector having a waterproof structure.

While the disclosure has been particularly described with reference to exemplary embodiments, it should be understood by those of skilled in the art that various changes in form and details may be made without departing from the spirit and scope of the disclosure.

1. A charging apparatus comprising:
a first power source connector configured to be connected to a charging station power source;
a second power source connector configured to be connected to a commercial power source;
a cable connected to the first power source connector and the second power source connector; and
a controller configured to determine whether one of the first power source connector and the second power source connector is connected to one of the charging station power source and the commercial power source, and to adjust the intensity of a charging supply current based on the determination result.

2. The charging apparatus according to claim 1, wherein the controller is further configured to determine an intrinsic resistance value of the connected power source, and to adjust the intensity of the charging supply current based on the determination result.

3. The charging apparatus according to claim 1, wherein the controller is further configured to monitor a state of being charged by the charging supply current.

4. The charging apparatus according to claim 3, further comprising
a charge breaker, wherein the controller is further configured to determine the monitoring result, and to control the charge breaker to stop charging when it is determined that charging is complete.

5. The charging apparatus according to claim 1, wherein the controller is further configured to accept a charging supply current of 32A, and to determine the charging supply current.

6. The charging apparatus according to claim 1, wherein the controller is further configured to accept a charging supply voltage of 110V to 230V, and to determine the charge supply voltage.

7. The charging apparatus according to claim 1, wherein the first power source connector and the second power source connector each comprise a cover having a screw thread.

8. The charging apparatus according to claim 7, wherein the cover of the first power source connector and the cover of the second power source connector each comprise a waterproof material.

9. The charging apparatus according to claim 1, wherein the first power source connector and the second power source connector are provided to be cross-detachable.

10. The charging apparatus according to claim 4, further comprising:
a communication device communicating with the charge breaker, wherein the controller is further configured to control the charge breaker to supply a charging current based on a communication result of the communication device.

11. A control method of a charging apparatus comprising:
connecting at least one of a first power source connector and a second power source connector to at least one of a charging station power source and a commercial power source;
determining a power source connector connected to the power source among the first power source connector and the second power source connector by a controller; and
adjusting the intensity of a charging supply current based on the determination result.

12. The control method according to claim 11, further comprising determining an intrinsic resistance value of the connected power source and adjusting the intensity of the charging supply current based on the determination result.

13. The control method according to claim 11, further comprising monitoring a state of being charged by the charging supply current.

14. The control method according to claim 13, further comprising determining the monitoring result and controlling a charge breaker to stop charging when it is determined that charging is complete.

15. The control method according to claim 11, further comprising accepting a charging supply current of 32A and determining the charging supply current.

16. The control method according to claim 11, further comprising accepting a charging supply voltage of 110V to 230V and determining the charge supply voltage.

17. The control method according to claim 11, further comprising controlling a duty ratio of a charge breaker signal when the second power source connector is connected to the power source.

18. The control method according to claim 11, further comprising changing the duty ratio based on a user input, wherein the control method further comprises changing the intensity of the charging supply current when the duty ratio is changed.

19. The control method according to claim 11, further comprising stopping control of the duty ratio when the first power source connector is connected to the power source.

20. The control method according to claim 14, further comprising communicating with the charge breaker, wherein the controlling comprises controlling the charge breaker to supply a charging current based on a communication result.
